(19) United States
(12) Patent Application Publication
(10) Pub. No.: US 2009/0125609 A1
(43) Pub. Date: May 14, 2009

(54) Method, apparatus, system and computer readable medium for providing a universal media interface to control a universal media apparatus

(75) Inventors: Anthony John Wood, Palo Alto, CA (US); Michael Joseph Kobb, Belmont, CA (US); Gregory Mack Garner, Springdale, AR (US); Daniel Sletten, Redwood City, CA (US); Donald Robert Woodward, JR., Monte Sereno, CA (US)

Correspondence Address: COOLEY GODWARD KRONISH LLP;ATTN: Patent Group, Suite 1100, 777 - 6th Street, NW, WASHINGTON, DC, 20001, US

(73) Assignee: Roku, LLC, Palo Alto, CA (US)

(21) Appl. No.: 11/479,156

(22) Filed: Jun. 29, 2006

Related U.S. Application Data
(63) Continuation-in-part of application No. 11/327,180, filed on Jan. 6, 2006.
(60) Provisional application No. 60/642,287, filed on Jan. 7, 2005.
(60) Provisional application No. 60/695,578, filed on Jun. 29, 2005.
(60) Provisional application No. 60/695,578, filed on Jun. 29, 2005.

(51) Int. Cl. G06F 15/16

(52) U.S. Cl. 709/219

(57) ABSTRACT

Various embodiments of the invention provide a method, apparatus, system and computer readable medium for implementing a universal media interface and control protocol to control a universal media apparatus. The universal media interface and its control protocol facilitate communication, including issuance of generalized commands between a target device, such as an audio/video (“A/V”) device and a universal music player, thereby enabling the target device to play music from different types of music servers and specialized server processes.

### CROSS REFERENCE TO RELATED APPLICATION

This application is a continuation-in-part of U.S. patent application Ser. No. 11/327,180, entitled “Universal Music Apparatus for Unifying Access to Multiple Specialized Music Servers,” filed on Jan. 6, 2006, which claims the benefit of U.S. Provisional Application No. 60/642,287, entitled “Universal Music Apparatus for Unifying Access to Multiple Specialized Music Servers,” filed on Jan. 7, 2005, and U.S. Provisional Application No. 60/695,578, entitled “Method, Apparatus, System and Computer Readable Medium for Providing a Universal Media Data Interface to Control a Universal Media Apparatus,” filed on Jun. 29, 2005. This application also claims the benefit of U.S. Provisional Application No. 60/695,578, entitled “Method, Apparatus, System and Computer Readable Medium for Providing a Universal Media Data Interface to Control a Universal Media Apparatus” filed on Jun. 29, 2005, the disclosures of all the aforementioned applications are incorporated herein by reference in their entirety for all purposes.

### BRIEF DESCRIPTION OF THE INVENTION

This invention relates generally to digital media players as well as music players, and more particularly, to a universal media interface (“UMI”) and control protocol to facilitate communication between a target device, in which the universal media interface is disposed, and a universal media apparatus, such as universal music apparatus, thereby enabling the target device to play music from different types of media and music servers.

### BACKGROUND OF THE INVENTION

Traditionally, music server processes are implemented on various computing device hardware platforms (i.e., music servers), to serve music in a digitized music format to networked clients. Generally, conventional music server processes include discovery protocols and communication protocols that both are proprietary and specialized. Because music server processes implement unique functions, so too must music clients, which are commonly referred to as “network music players,” or just music players. Similarly, “network media players” media players also implement proprietary and specialized protocols to stream video and/or still images as well as audio.

While conventional media and music players are functional, there is a common drawback in the implementation of a single music player when two or more different music server processes share the same network. As traditional music players are compatible with a limited number of discovery protocols and communication protocols (usually limited to one of each), music data stored on another server having different protocols would be inaccessible to most music players that do not operate with the same protocols.

FIG. 1 illustrates another drawback with traditional media players. Namely, conventional music servers, such as specialized music server (“SMS1”) 108, include server control logic 110 necessary to implement the music server processes. Consequently, server logic 110 typically resides on the music server side (e.g., at the computing device hardware platform, such as a PC or Mac™ computer), with traditional music player one (“TMP1”) 102 acting as somewhat of a “thin client” controlled by the music server. For example, traditional music player one 102 generates and transmits only server-specific commands 104 via network to specialized music server 108 to initiate playback of music. By placing server control logic 110 on the server side of network 106, it is difficult for specialized music server 108 to be modified to universally interact with other specialized music servers, such as another traditional music player two (“TMP2”) 122. Traditional music player two 122 uses it own specialized server-specific commands 124 to access server logic 120 of specialized music server (“SMS2”) 128. Incompatibilities arise from the differences in communication protocols (as well as the discovery protocols) used to convey server-specific commands 104 and 124. And as neither specialized music servers 108 and 128 typically provide an adequate interface for communicating universally with various target devices and target proprietary configurations, a designer of a target device has to learn multiple server protocols to integrate the music players; functionality into the target device. For example, original equipment manufacturers (“OEMs”) that desire to integrate functionalities of a music (or media) player into their products cannot readily do so using server control logic 110 and 120, especially if those OEMs strive to enable their products to access music from two or more different music server processes. OEMs typically manufacture electronic products such as music systems (e.g., CDs and DVD players, as well as broadcast radio tuners), audio/video (“A/V”) receivers, televisions, radios, etc.

In view of the foregoing, it would be highly desirable to provide a universal media interface (“UMI”) for communicating with a universal media apparatus, such as a universal music apparatus, whereby the UMI is configurable to provide non-standard target devices with universal (or standardized) control over a universal music apparatus.

### SUMMARY OF THE INVENTION

Various embodiments of the invention provide a method, apparatus, system and computer readable medium for implementing a universal media interface to control a universal media apparatus. The universal media interface and control protocol facilitate communication, including issuance of generalized commands, between a target device, such as an audio/video (“A/V”) device and a universal music player, thereby enabling the target device to play music (and optionally video) from different types of music servers. The universal media interface (“UMI”) allows consumer electronics device manufacturers to quickly and easily integrate networked music playback functionality into their products. In one embodiment, an apparatus provides music-related requests from a target electronic device to one or more specialized music servers operating with different server protocols. The apparatus includes a request decoder configured to decode a music-related request to communicate with at least one specialized music server using one of a plurality of different server protocols, as well as a command control protocol module configured to generate a generalized music-related command in response to the music-related request. It can also include a universal music apparatus module configured to access multiple specialized music servers in response to the generalized music-related command. Further, the apparatus can include an optional universal media data link configured to convey the generalized music-related command from the command control protocol module to the universal music apparatus module. The multiple specialized music servers generally implement incompatible server protocols.

In another embodiment, the UMI is configured to accept user input from a target device to initiate commands to a universal music apparatus, thereby causing the universal music apparatus to automatically discover and communicate with multiple media servers, such as Windows Media Connect™ manufactured by Microsoft, Inc. running on a local network. In at least one embodiment, Internet radio stations are also fully supported, with on-board radio presets that can be stored and recalled by the user at the touch of a button or any other user input configured to initiate commands via the UMI. In one embodiment, the UMI and a universal music apparatus cooperate to implement, for example, a UPnP-AV music renderer, thereby allowing third-party devices to control it using the open UPNP protocol. In a specific embodiment, the UMI and a universal music apparatus cooperate to expose an on-board web page allowing control from any web browser on the local network.

In a specific embodiment, the universal music apparatus is implemented as a module that can be integrated into a target device, thereby supporting network music playback in a custom consumer electronics application. As such, the UMI control protocol allows a processor, such as a microcontroller or microprocessor, in a target device to interactively access any of the built-in functionality of a universal music apparatus module and to retrieve the results of those actions in a synchronous or asynchronous manner. The universal music apparatus module implementing UMI can additionally render a user interface suitable for sending to a bitmapped or character-based display, or the like, and the target device can use the content enumeration and selection primitives in the UMI control protocol to create their own custom UI. In one embodiment, a UMI includes a universal API (“application programming interface”) to support communications with a variety of operating systems and application programs.

Advantageously, the UMI control protocol provides a generalized message structure that provides a standardized interface for developing applications for a universal music apparatus integrated with a target device. This significantly reduces the complexity of providing digital music and video via a network and eliminates the cost of supporting an interface composed of numerous specialized messages for various specialized music servers.

By issuing UMI control protocol commands to a universal media apparatus module over a serial bus, for example, any consumer electronics product can play Internet radio or digital music over a home network. An embedded universal media apparatus module can handle the complicated work behind the scenes with its embedded and powerful network music processor. Embedded universal media apparatus module distills complicated tasks such as WiFi certification, WiFi drivers, support for multiple server types, digital rights management, compatibility testing, and internet radio to a simple set of serial commands. The flexibility of this approach allows an OEM to create a fully custom user interface if they wish, or use the universal media apparatus module's built-in user interface primitives.

### BRIEF DESCRIPTION OF THE FIGURES

The invention is more fully appreciated in connection with the following detailed description taken in conjunction with the accompanying drawings, in which:

FIG. 1 is a diagram showing conventional music players networked to respective traditional specialized music servers;

FIG. 2 is a block diagram illustrating a universal media interface, according to one embodiment of the invention;

FIG. 3 is a block diagram illustrating a target device implementing a universal media interface for accessing music from multiple specialized music servers, according to one embodiment of the invention;

FIG. 4 is a block diagram of a universal media data link including a universal media interface, according to one embodiment of the invention;

FIG. 5 shows an A/V Device as an example of a target device implementing a universal media interface as part of a universal media data link (“UMDL”), according to one embodiment of the invention;

FIG. 6 is a functional block diagram of a universal media interface generating generalized commands in accordance with a UMI control protocol, as set forth in at least one embodiment of the invention;

FIG. 7 depicts implementation of a universal music apparatus module (“UMAM”) according to one embodiment of the invention;

FIG. 8 illustrates a system including a universal music apparatus, according to at least one embodiment of the invention;

FIG. 9 is a flow diagram exemplifying a method with which a universal music apparatus forms a music server object, according to an embodiment of the invention;

FIG. 10 shows an example of a music server model from which a music server object is formed, according to one embodiment of the invention;

FIG. 11 introduces an architecture in which music server objects (“MSOs”) are implemented in a computing device to unify accesses to a number of specialized music servers, according to at least one embodiment of the invention;

FIGS. 12A and 12B illustrate examples of user interfaces implemented by UI module, according to various embodiments of the invention; and

FIG. 13 depicts the implementation of a play list referencing songs stored in multiple specialized servers, according to one embodiment of the invention

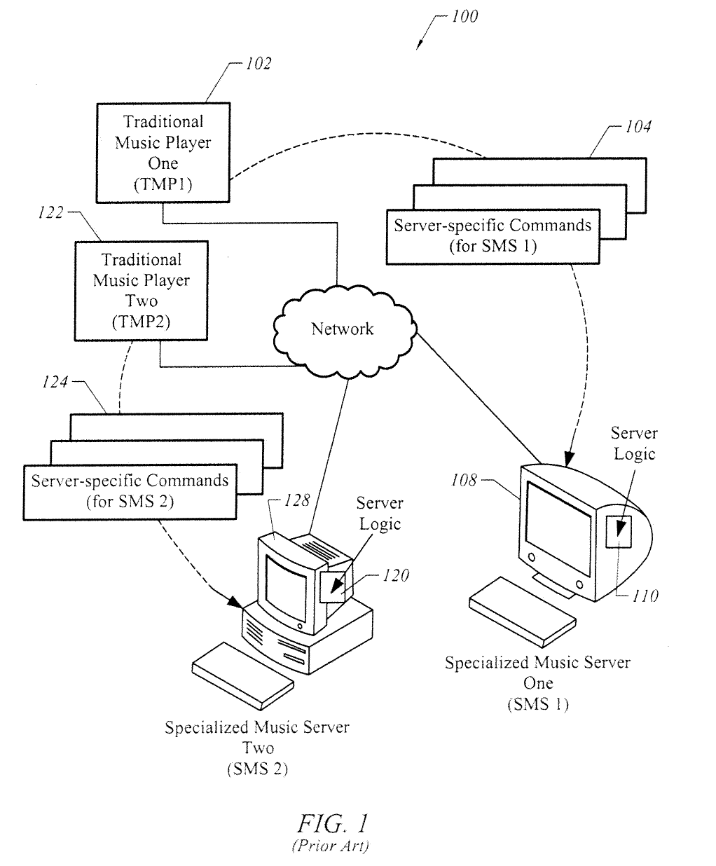

Like reference numerals refer to corresponding parts throughout the several views of the drawings. Note that most of the reference numerals include one or two left-most digits that generally identify the figure that first introduces that reference number.

### DETAILED DESCRIPTION OF EXEMPLARY EMBODIMENTS

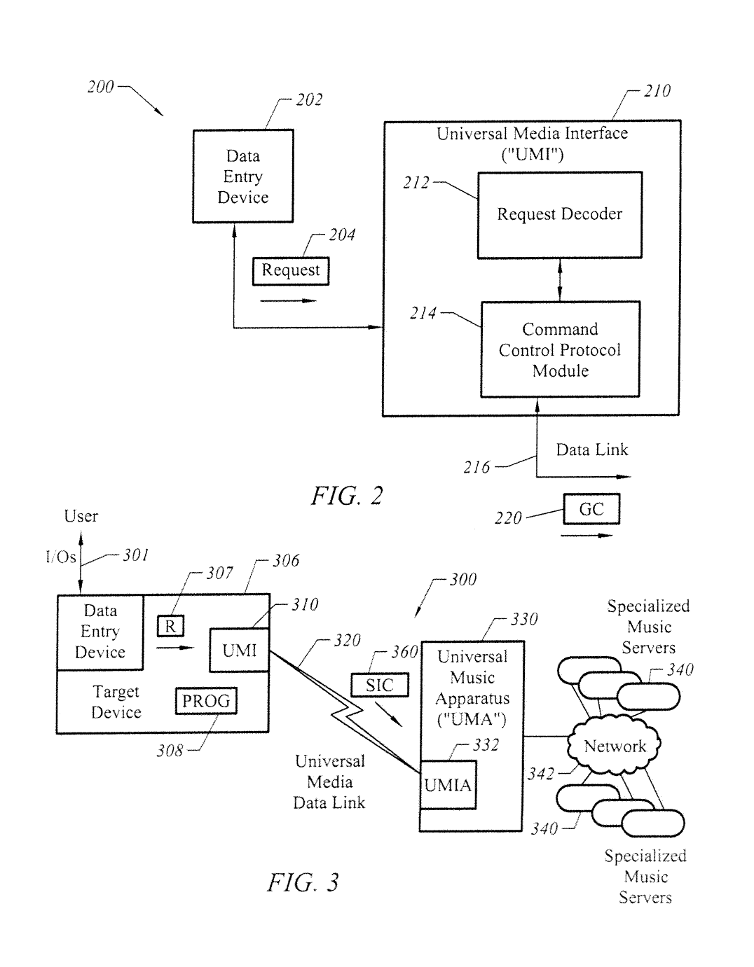

FIG. 2 is a block diagram illustrating a universal media interface, according to one embodiment of the invention. Diagram 200 depicts a universal media interface (“UMI”) 210 that converts a request 204 from a target device (not shown) into a generalized command for interacting with any of one or more specialized media servers (not shown), at least two of which operate with different server protocols. Universal media interface 210 includes a request decoder 212 and a music server command control protocol module (“control protocol module”) 214. Request decoder 212 is configured to decode request 204 to form a decoded request for communicating with specialized media servers. Request 204, for example, can originate at a data entry device 202 through which a user enters data representing a function to be performed by the target device. Further, request 204 is usually generated in a format defined by a proprietary application program of a target device, the format being insufficient to communicate universally with specialized media servers. Command control protocol module 214 is configured to generate a generalized command (“GC”) 220 based on the decoded request for invoking a response from any of the one or more specialized media servers. The term “generalized command” in some embodiments refers to a command that independent of the different server protocols associated with the different specialized servers. As in the case shown in FIG. 2, generalized command 220 is independent of the different server protocols and therefore neither request 204 nor generalized command 220 need specify server-specific protocols. Further, command control protocol module 214 transmits generalized command 220 via a data link 216. Advantageously, universal media interface 210 enables designers of target devices to use generalized commands rather than server-specific commands to access multiple specialized media (or music) servers. As such, a target device (e.g., a consumer electronic device) can implement a universal music apparatus for accessing music and music-related information without requiring the target device to implement service-dependent protocols. This simplifies development and reduces cycle time in the manufacture of consumer products that access music and its related information from sources over a network.

FIG. 3 is a block diagram illustrating a target device implementing a universal media interface for accessing music from multiple specialized music servers, according to one embodiment of the invention. Diagram 300 depicts a universal media interface (“UMI”) 310 embedded in a target device 306, which also includes a data entry device 302 for entering inputs and providing outputs (“I/Os”) 301 in relation to a user. Target device 306 also includes a proprietary applications program (“prog”) 308 composed of executable instructions that provide the functionality for target device 306, which can be a television or an A/V receiver. Conventionally, proprietary applications program 308 does not include the functionality to access multiple music servers having incompatible server protocols with a server-independent command (“SIC”) 360. In operation, universal media interface 310 decodes a music-related request (“R”) 307, and, in response, transmits a generalized music-related command, such as SIC 360, via universal media data link 320 to a universal music apparatus module 330. Universal media interface 310 enables target device 306 to, for example, initiate either different discovery protocols to identify multiple specialized media servers, or different communication protocols to interact with the multiple specialized media servers, or both. As used herein, the term “specialized server” in some embodiments generally refers to a server associated with either a specific discovery protocol, or a specific communication protocol, or both, where those specific discovery and communication protocols are typically incompatible with other discovery and communication protocols for another such server. Examples of different discovery protocols include Simple Service Discovery Protocol (“SSDP”) and Bonjour™, which is a registered mark of Apple Computer, Inc. Examples of different communications protocols include the Universal Plug and Play™ (“UPnP”) protocol and Digital Audio Access Protocol (“DAAP”).

Universal music apparatus 330 includes a universal media data link adapter (“UMIA”) 332 for receiving the generalized commands in accordance with the UMI control protocol. In operation, universal music apparatus 330 functions to access any specialized music server 340 via network 342 for exchanging data to play media, such as music, regardless of the specialized music server processes running on specialized music servers 340. Universal media apparatus 330, according to one embodiment of the invention, is a universal music apparatus as set forth in U.S. Provisional patent application 60/642,387 filed on Jan. 7, 2005 titled “Universal Music Apparatus for Unifying Accesses to Multiple Specialized Music Servers,” which is incorporated by reference for all purposes. In one instance, universal media data link adapter 332 automatically controls at least some of the functions that are described as being manually-controlled by a user in U.S. Provisional patent application 60/642,387. The elements of FIG. 3 can be implemented in either hardware or software, or both.

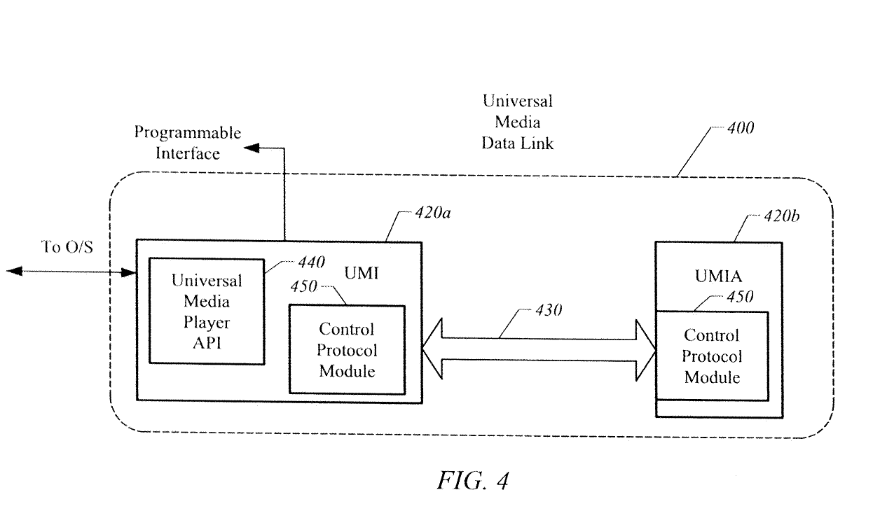

FIG. 4 is a block diagram illustrating a universal media data link including a universal media interface, according to one embodiment of the invention. In this example, universal media data link (“UMDL”) 400 includes a universal media interface (“UMI”) 420a coupled via a communications link 430 to a universal media data link adapter (“UMIA”) 420b. Communications link 430 can be physical medium, such as one or more wires, or it can be a wireless link. Advantageously, universal media data link 400 and the attendant UMI control protocol enable original equipment manufacturers (“OEMs”) to integrate functionalities of a music (or media) player with or into a target device regardless of the device's relative distance in relation to the universal music player. Further, the UMI control protocol provides a standardized way of accessing music/media from two or more different music/media server processes.

In one embodiment of the invention, UMI 420a implements a universal media apparatus application program interface (“API”) 404 configured to exchange data with an operation system (“O/S”) and/or an applications program of the target device (not shown). UMI 420a also includes a control protocol module 450 for at least transmitting generalized commands over communications link 430. Correspondingly, UMIA 420b includes a control protocol module 450, and is configured primarily to adapt commands sent from UMI 420a to control operation of the universal music apparatus. Advantageously, universal media apparatus API 404 exposes algorithmic elements (i.e., functions) of universal media (or music) apparatus 402 to software and hardware developers of consumer electronics, while hiding the details of the universal music apparatus module by implementing generalized commands. Universal media data link 400 offers a robust control interface that allows target devices to exert control over the details of digital media streaming. The UMI control protocol, therefore, facilitates integration of digital media support into target consumer devices without investing significant development time on a new user interface or complex operating modes.

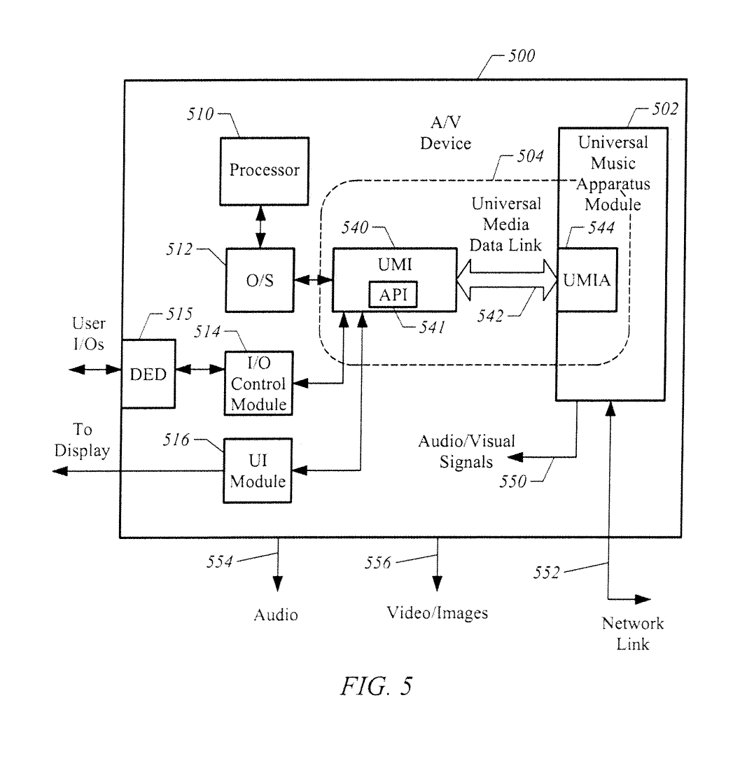

FIG. 5 is a block diagram illustrating an A/V Device as an example of a target device implementing universal media interface as part of a universal media data link (“UMDL”) 504, according to one embodiment of the invention. Here, universal music apparatus 502 is implemented as universal media apparatus module, which can be a board-based module (i.e., formed on a printed circuit board), or it can be formed on a single semiconductor substrate (e.g., a system on a chip, or as a “SOC”). Universal media data link 504 includes a universal media interface 540. Also, universal media data link 504 contains a universal media apparatus API 541 configured to exchange data via physical communications link 542 with universal media apparatus module 502. Examples of physical communications link 542 include parallel buses and/or serial buses, which can implement RS 232, SPI, I²S, or the like. A processor 510, such as a CPU or microcontroller, executes program instructions (e.g., stored in program memory—not shown) representing universal media apparatus API 541, which operates to provide an interface with an operation system (“O/S”), for example.

In operation, universal media interface adapter 544 receives a generalized command that is used to control the operation of universal media apparatus module 502. For example, universal media apparatus module 502 can generate server-specific commands and transmits those commands via network link 552. The resultant digitized music and/or music-related information returns to universal media apparatus module 502, which then generates audio/visual signals 550 compatible with particular CODECs and/or formats. AN device 500 then applies the particular CODECs and/or formats to generate audio 554 and video/still images 556.

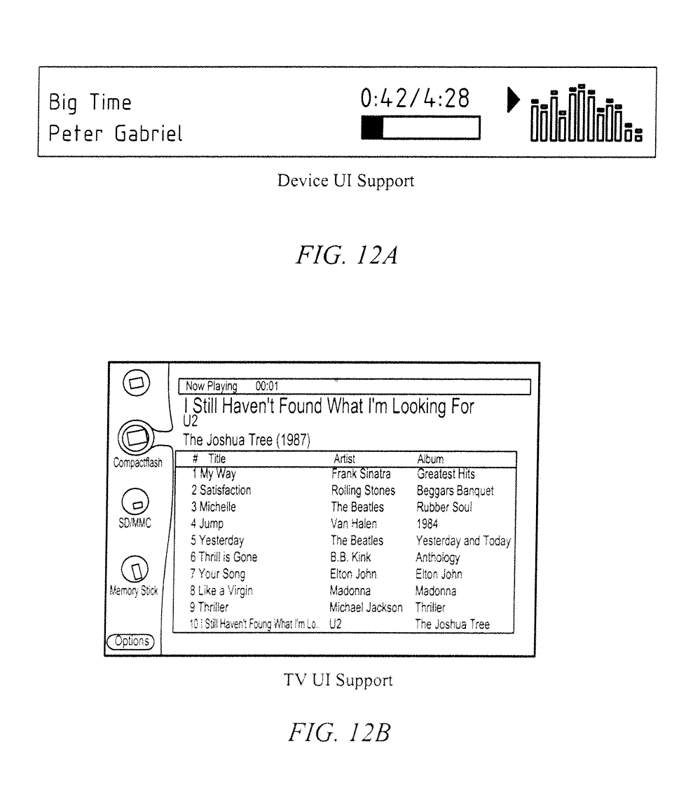

In various embodiments, universal media apparatus API 541 is designed to interface with an input/output (“i/o”) control module 514 to implement A/V-specific inputs and outputs via a data entry device (“DED”) 515. For example, data entry device 515 can include push-buttons for implementing selection of, for example, Internet Radio Presets. As such, the user can play Internet radio stations. The user initiates playback by pressing a “preset button” on, for example, a remote or front panel interface. Processor 510 then executes instructions causing universal media apparatus API to send a “PlayInternetRadioPreset” command to universal media apparatus module 502 to begin playback. In one embodiment, universal media apparatus module 502 comes configured with the presets set to select internet radio stations, with the presets being configurable by a user. Generally, data entry device 515 can include a key-pad, infra-red transmitter (e.g., a remote control), or any similar data entry mechanisms for entering user inputs into A/V device 500. In a specific embodiment, user interface (“UI”) module 514 supports generation of a UI, such as generated by universal media apparatus (e.g., as a built-in UI) shown in FIG. 12A or as implementing a content-rich UI as shown in FIG. 12B. The modules of FIG. 5 can be implemented in either hardware or software, or both.

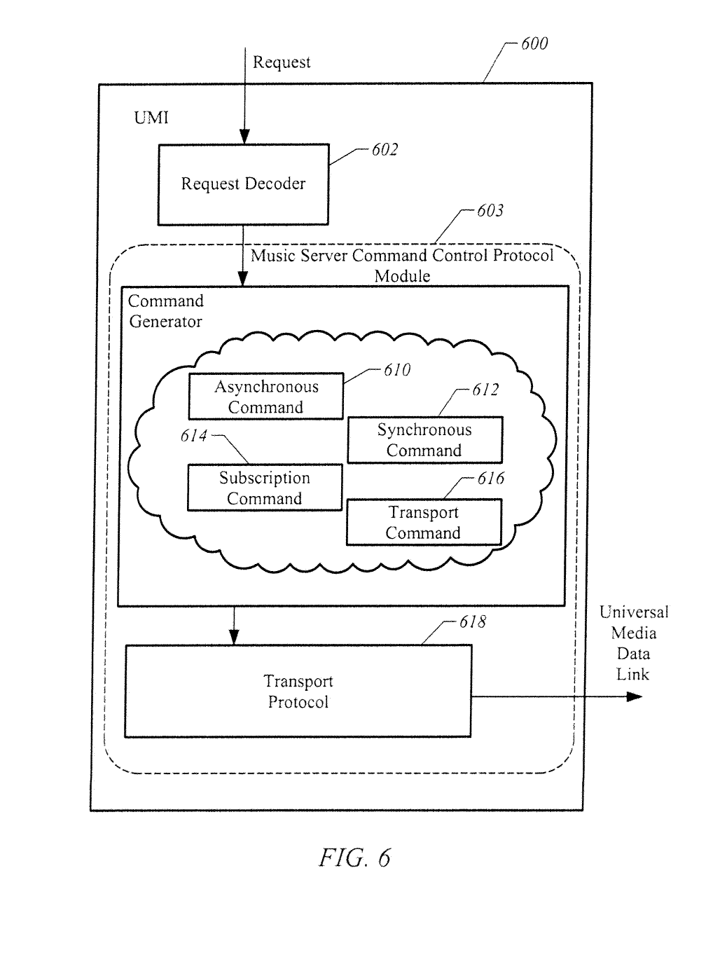

FIG. 6 is a functional block diagram of universal media interface implementing a UMI control protocol, according to an embodiment of the invention. UMI 600 includes a request decoder 602 and a command control protocol module 603, which includes a command generator 604 and a transport protocol 618. In operation, request decoder 602 translates a request in a format useable by a proprietary program used by a target device. For example, request decoder 602 can decode a request into an asynchronous command 610, a synchronous command 612, a subscription command 614 or a transport command 616. Command generator 604 then constructs a specific generalized command, such a ListServers command, before formatting the generalized command for transmission. Such formatting is performed by transport protocol 618.

Transport protocol 618 can include, but is not limited to implementing SPI, I²C and RS-232. SPI refers to the “Serial Peripheral Interface” bus standard for controlling digital electronics that accept a clocked serial stream of bits. I²C (“Inter-Integrated Circuit”) is a serial computer bus protocol invented by Philips, Inc. RS-232 is a standard for serial binary data interconnection between a data terminal equipment (“DTE”) and a data communication equipment (“DCE”).

### Protocol Summary

The UMI Control Protocol has been designed with simplicity and completeness as primary requirements, among others. Commands and results are generally exchanged as short transmissions across a high-speed interface like a serial port, telnet connection, parallel interface, or the like. Each target device command can be composed of a short ASCII command id string, zero or one parameters, and a single-byte terminator (a new line character). All command results from the Universal Media Apparatus Module are composed of the command-id of the command that caused this result followed by a result string and the new line terminator.

I. Synchronous Commands

Synchronous commands are returned immediately (typically within 1 ms) by the universal media apparatus module before processing any further target device-invoked commands (or returning any other results from the universal media apparatus module). In particular, a synchronous music-related command requires a response from the universal music apparatus module before the command control protocol module transmits a subsequent music-related command for execution. A basic type of synchronous command can be illustrated by the following example of the command GetTransportState, which is a command that takes no parameters and returns a single status result:

### Example

Get TransportState

GetTransportState: stopped

The target device sends the command id (“GetTransportState”) followed by a new line character (‘\n’ or char code 0x0a), and the universal media apparatus module responds with the result string composed of the originating command id, a colon and space separator, the status result (“stopped”), and terminating new line character.

A. Listing and Connecting to Music Servers

The following commands allow a target device to generate generalized commands to list, connect to, and disconnect from different media servers on the network.

The UMA automatically detects content servers advertising using the UPnP/AV, DAAP, SlimServer, and other similar protocols. Target devices may specify what types of media servers to list by using the SetServerFilter command below. After getting a list of servers with the ListServers command, the target device may use the ServerConnect command.

(1.) ListServers Command

This generalized command creates a list of music servers on the local network. The list can be sorted alphabetically by name and can contain servers of the types indicated by the current server filter, which can be set with SetServerFilter command. By default, all server types are listed in some embodiments. In some cases, the UMA automatically searches the local network for media servers in the background to return the current list of servers detected.

### Example

Syntax: ListServers

ListServers: ListResultSize 3

ListServers: Some Server Name

ListServers: Some other server name

ListServers: Favorite Radio Stations

ListServers: ListResultEnd

(2.) SetServerFilter Command

This command sets which types of music servers should be returned by the command ListServers. The parameters to SetServerFilter can be a space-delimited list of the following tokens (capitalization can be ignored): “DAAP”—to select servers using DAAP protocol, “UPnP”—to select servers using UPNP AV protocol (e.g., Windows Media Connect, Rhapsody, MusicMatch, etc.), “slim”—to select open-source SlimServer protocol, “radio”—to select a list of Internet Radio Stations as a server entry for listening to internet radio stations directly, “flash”—to select directly a connected device containing a portable media (e.g., a flash card physically inserted into a slot on the device), “Tuner” to select an AM/FM radio tuner as a source of audio, and “all”—to list all server types.

### Example

Syntax: SetServerFilter [DAAP|UPnP|slim|radio|flash|tuner|all]

SetServerFilter DAAP

SetServerFilter: OK

(3.) ConnectServers Command

This generalized command creates a connection with the n^{th} music server in a list returned by the ListServers command.

### Example

Syntax: ServerConnect n

ServerConnect 0

ServerConnect: TransactionInitiated

ServerConnect: TransactionComplete

ServerConnect: Connected

B. Transport Commands

The following commands alter playback of music from the music servers. Transport commands are server-independent commands that provide for the following playback actions: Play, Pause, Next, Previous, Stop, Shuffle, Repeat, etc.

### Example

Syntax: Play

Play

II. Asynchronous Commands

Asynchronous commands are transacted commands that can take some time to complete execution, and therefore use a slightly different calling convention. For example, one command might query a music server for a list of songs, which will require a network transaction with the server device that can take as long as several seconds to either complete or time out. Asynchronous commands generally return results asynchronously (e.g., over the command interface) during pendency of the command. Preferably, the target device and its API are designed to parse the results of asynchronous commands after they have been issued. The target device and its API can also cancel a pending transacted command at any time during its lifetime if some user action (or other event) requires it.

A. Content Selection and Playback

The following commands allow a target device to generate generalized commands to list, organize, and play back music tracks stored on a music server.

(1.) List Commands

These generalized commands list songs, albums, artists, composers, genres, play lists, play list song, etc., each of which can be similar to the following command.

### Example

Syntax: ListPlaylistSongs

ListPlaylistSongs: TransactionInitiated

ListPlaylistSongs: ListResultSize 2

ListPlaylistSongs: Zealots

ListPlaylistSongs: Commodores—Brick House

ListPlaylistSongs: ListResultEnd

ListPlaylistSongs: TransactionComplete

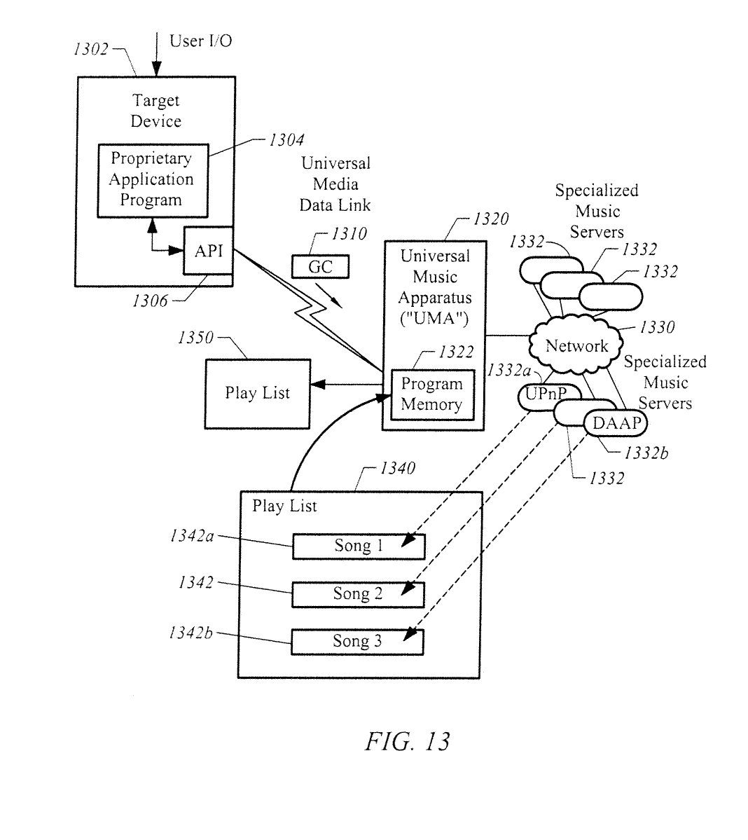

Advantageously, command generator 604 can generate a single command to generate a single play list of songs even though those songs might reside on different specialized music servers responsive to different communication protocols. Further, another generalized command, such as the Play command, can implement such a list to begin playback independent of incompatible server protocols. For example, the “ListPlaylistSongs” command can generate a—play list containing data representing the song “Zealots,” which is procured using a first communications protocol with a first server, and the song “Brick House,” which is retrieved using a second communications protocol with a second server. FIG. 13 describes an example of one type of play list formed by a generalized command, whereby a user can access the play list to perform music-related operations (e.g., playing select songs, inserting a song into a play list, removing a song from the play list, etc.) by invoking generalized commands irrespective of the different server protocols.

In the following example, a target device makes a request that is decoded as command ListArtists to get the list of music artists from a music server. Note the elapsed time column to the left of each transmission, which suggests a possible timing scenario for this command (although the actual timing of this command will be different and unpredictable in practice).

| Elapsed Time | |
|---|---|
| (arbitrary units) | Transactions |
| 0 | ListArtists |
| 1 | ListArtists: TransactionInitiated |
| 400 | ListArtists: ListResultSize 3 |
| 400 | ListArtists: Counting Crows |
| 400 | ListArtists: Dire Straits |
| 400 | ListArtists: Led Zeppelin |
| 400 | ListArtists: ListResultEnd |
| 400 | ListArtists: TransactionComplete |

Although there are many asynchronous commands in the UMI Control Protocol, generally a single one can be active at any time, in some embodiments. If the target device requires another command to execute instead of the currently active asynchronous command, they should cancel the command in progress before issuing the next one (or wait for it to complete). However, other commands can be issued and completed while an asynchronous command is being processed.

Another generalized command can generate a list of music-related data including information related to songs, albums, artists, composers, genres, play lists, play list song, etc., each of which can be similar to the following command.

### Example

Syntax: GetSongInfo index
GetSongInfo 0
GetSongInfo: TransactionInitiated
GetSongInfo: id: 11453852
GetSongInfo: trackLengthMS: 384627
GetSongInfo: trackNumber: 9
GetSongInfo: format: MP3
GetSongInfo: status: unsupported
GetSongInfo: title: Lovely Day
GetSongInfo: artist: Bill Withers
GetSongInfo: album: Lean On Me
GetSongInfo: genre: Rock
GetSongInfo: comment: flac-to-mp3 version 1.5
GetSongInfo: songFormat: mp3
GetSongInfo: formatDescription: mp3 audio file
GetSongInfo: resource[0] url: h_t_t_p://192.168.0.150:3689/databases/1/items/11453852.mp3 ?session-id=4 GetSongInfo: resource[0] format: MP3
GetSongInfo: resource[0] bitrate: 128
GetSongInfo: resource[0] sampleRate: 44100
GetSongInfo: resource[0] sizeBytes: 6154036
GetSongInfo: OK
GetSongInfo: TransactionComplete

In this example, the GetSongInfo command reports attributes of, for example, a song with an index as reported by a specialized server. The index argument can refer to any list of songs generated by, for example, a browsing or searching command.

B. Searching

The following commands allow a target device to generate generalized commands to search one or more music servers for a particular string as an argument.

(1.) Search Commands

These generalized commands search for strings in songs, albums, artists, composers, or all the above, each of which can be similar to the following command.

### Example

Syntax: SearchSongs <search_string>

SearchSongs ever

SearchSongs: TransactionInitiated

SearchSongs: ListResultSize 5

SearchSongs: El Distorto De Melodica

SearchSongs: Tomorrow Never Knows

SearchSongs: Everything—Whos Got The Hooch

SearchSongs: Fever Dream

SearchSongs: I'm A Believer

SearchSongs: ListResultEnd

SearchSongs: TransactionComplete

III. Subscription Commands

In some cases a target device request status updates on state changes in the universal media apparatus module over a long period of time, spanning the interaction of many synchronous and transacted commands. For example, the target device may wish to have the universal media apparatus module notify the target device via its API automatically every time there is a change in the transport state, e.g., when the currently playing track changes, or when there is a buffer underrun during playback. (On the other hand, some target device configurations may prefer to poll for these status changes by requesting the current transport state with a synchronous command issued every 500 ms, e.g.)

To accommodate this kind of long-term status notification, there is a set of commands called subscription commands that causes the universal media apparatus module to asynchronously publish status updates over the universal media interface, or UMI, whenever a related change in state occurs. (Note that these status updates can interleave with results from transacted commands and in-between issuances of synchronous commands.)

In the following example, the target device subscribes to TransportState update events, and then issues the Next command (to skip to the next track) during playback.

| Elapsed Time | |
|---|---|
| (arbitrary units) | Transaction |
| 0 | SubscribeTransportUpdateEvents |
| 1 | SubscribeTransportUpdateEvents: ok |
| 1 | TransportEvent: playing |
| 1000 | Next |
| 1000 | Next: ok |
| 1005 | TransportEvent: trackchange |
| 1010 | TransportEvent: buffering |
| 2000 | TransportEvent: playing |

IV. Other Commands

A. List Results

Several commands (like the aforementioned ListArtists) return a list of results. Sometimes, these lists can be unwieldy in size, approaching 10,000 items in the most extreme cases (listing all songs in a large music library). The UMI Command Protocol includes a method for retrieving partial list results from these commands.

The target device and/or its API can toggle the current list result type between full and partial by issuing a SetListResultType command, which causes all subsequent commands returning list results to return results in the specified manner. When in partial result mode, the target device and/or its API uses the command GetListResult to browse a subset of the list results, specified by zero-based numeric indices. Note that generally one set of results can be browsed at a time; the issuance of another command generating list results will replace the current set of list results, which may not be accessible any longer. In the following example, the client uses partial results to browse all songs on a music server.

| Elapsed Time (ms) | Transactions |
|---|---|
| 0 | SetListResultType partial |
| 1 | SetListResultType: ok |
| 2 | ListSongs |
| 2 | ListSongs: TransactionInitiated |
| 5000 | ListSongs: ListResultSize 5123 |
| 5000 | ListSongs: TransactionComplete |
| 5001 | GetListResult 0 2 |
| 5002 | GetListResult: ListResultSize 3 |
| 5002 | GetListResult: Ace Of Spades |
| 5002 | GetListResult: Alison |
| 5002 | GetListResult: All Mixed Up |
| 5003 | GetListResult: ListResultEnd |

B. UMA-Generated User Interface

Depending on the scope of the target device, target devices may wish to take advantage of the universal media apparatus module's ability to generate a user interface. The universal media apparatus module can maintain a bitmapped or character-based UI which can be transferred back to the target device using the UMI control interface as a bitstream (for bitmapped display) or character strings (for character-based displays). For example, consider Roku's SoundBridge as an example of such a UI that universal media apparatus module generates.

To interact with the universal media apparatus module's UI, a target device should issue IR commands (i.e., “infra-red” commands, basically the type of buttons one might find on a remote control) using a universal media apparatus module command IrDispatchCommand. For example, if one dispatches the MENU command, then in most cases the universal media apparatus module-generated UI will display a menu with a list of options for the user to choose from.

To keep one's physical display up to date with changes to the universal media apparatus module-generated UI, one can subscribe to display-update events (to receive notification whenever the UI has changed), or one can poll for a display-update counter, or one can simply download the display data (using the command GetDisplayData) several times a second.

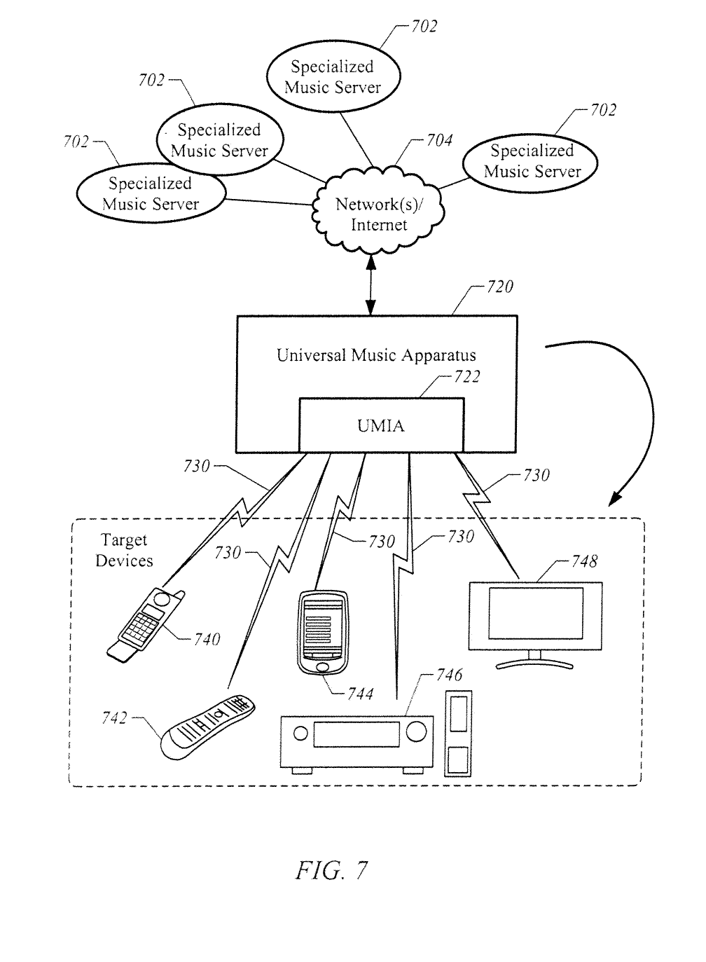

FIG. 7 depicts implementation of a universal music apparatus module (“UMAM”) according to one embodiment. UMAM 720 includes a UMIA 722 and implements a UMI control protocol over links 730 to one or more target devices. Examples of target device includes a wireless phone 740, a remote control 742, a personal digital assistant (“PDA”), an A/V receiver 746, and a television set 748. In some embodiments, UMA 720 can be enclosed within a housing for any of target devices 740 to 748. As described above, UMA 720 communicates via network 704 to specialized music (or media) servers 702. In one embodiment, UMA 720 can operate in “stand alone mode,” where host processor 510 of FIG. 5 is absent from a particular target device, or is disabled. In such a situation, UMA 720 can be controlled using an Ethernet connection, a wireless link, or some other interface using either Telnet or the built in web page, for example. In one embodiment, UMA 720 includes the functionality of a SoundBridge™ and optionally a HD Photo Bridge™, both of which are manufactured by Roku, LLC of Palo Alto, Calif.

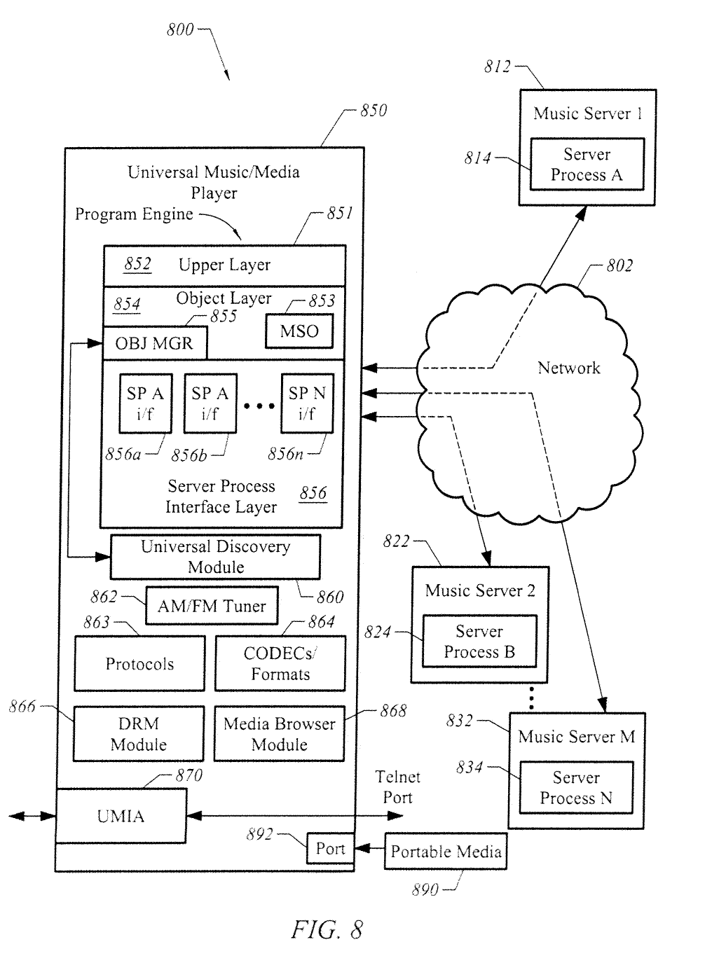

FIG. 8 is a system 800 including a universal music apparatus, according to at least one embodiment of the invention. In particular, FIG. 8 depicts a universal music apparatus 850 coupled via a network 802 to a number of music servers. Universal music apparatus 850 is configured to exchange data with music server (“1”) 812, music server (“2”) 822 and music server (“M”) 832, each respectively implementing server process (“A”) 814, server process (“B”) 824 and server process (“N”) 834. These server processes are each different, and as such, are incompatible with each other. In particular, each server process can represent either a unique discovery protocol or a unique communication protocol, or both, as well as any other protocol useable in serving music to a client music player. In a specific embodiment, network 802 is a local network, such as a digital home network (e.g., wired or wireless), and music servers 812, 822 and 832 are each composed of a computing device configured to execute instructions representing the server processes. Note that each of music servers 812, 822 and 832 can include or can couple to a memory (not shown) for storing music data and music-related data in a data structure. In at least one embodiment, different data access protocols are used for different music servers for interacting with (e.g., querying) those data structures.

Advantageously, universal music apparatus 850 is configured to automatically detect and identify music servers and the server processes implemented therein. In various embodiments, each of the server processes in music servers 812, 822 and 832 is detectable by universal music apparatus 850. That is, universal music apparatus 850 is configured to detect the different types of server processes 814, 824 and 834 of which it is capable of detecting (i.e., predetermined prior to discovery). Further, universal music apparatus 850 is configured to access music and related information irrespective of the underlying communications and/or data access protocols. As such, universal music apparatus 850 interfaces with music servers that provide both browse and search (or query) capabilities, as well as basic music servers that only provide browsing capabilities. As used herein, the terms “browse” and “browsable” are used in some embodiments to describe a method of exporting data from a music server in which data resides. Browsing accesses data by recursively exploring a hierarchy of directories or folders. Generally, a user is presented a list of indicators (e.g., artist, genre, etc.) associated with parent folders that, when selected, will present items of the selected folder to a user. As an example, consider that a user wishes to browse all the “artists” of a music library. Upon initiating “browse ARTISTS,” the user interface can present an alphabetical listing of the artists. Then, the user scrolls up and down the list until a desired artist is found. The terms “search” and “searchable” are used in some embodiments to describe a method of exporting data from a music server in which data can be retrieved using a query language or instructions (i.e., without traversing a hierarchy of folders). Searching or querying a music server uses tags that specify, for example, a title, an artist, an album, a year, a genre, a composer, and the like. For instance, consider that a user wishes to search for a specific “artist” by the name of ARTIST_ONE. Upon initiating “search ARTISTS,” the user interface will present a text field so that the user can enter a string of one or more alpha-numeric characters to match against a data structure of a searchable database. In particular, the user will enter some or all of the following characters: A, R, T, I, S, T, _, O, N, and E to form a query. After a match is found, the user will be presented with the artist name of ARTIST_ONE. Note that UPNP and DAAP music servers include communications and data access protocols for performing queries and can respond by exporting music and music-related data corresponding to query or search parameters specified by user input. Also note that data representing music in a “browse-only” server is not configured for retrieval using a query language, unlike a searchable music server. As used herein, the term “music data” in some embodiments refers to data used to produce music (note that a music file contains sufficient music data to render one or more songs), whereas the term “music-related data” refers to peripheral data that describes the music data (e.g., data representing artist information) or the functions of playback. The term media refers in some embodiments to data used to produce either visual images or audio.

So according to the invention, universal music apparatus 850 can serve as the sole client computing device on a network of disparate server processes. Further, it can provide for a user interface to convey generalized user inputs and outputs that are independent of the specialized server processes without, for example, manual intervention (e.g., without modifying executable instructions to adapt to each specialized server process). By contrast, traditional techniques of serving music to client music players rely on the music players being designed to accommodate those server processes of a specific music server. Generally, music players cannot support more than one type of server process. Note that universal music apparatus 850 optionally includes one or more additional modules, as is discussed below.

Universal music apparatus 850 can be viewed as a client computing device including a program engine 851 and a universal discovery module 860, either of which can be composed of hardware or software, or both. Program engine 851 includes various layers representing abstractions of program instructions, including upper layer 852, object layer 854 and server process interface layer 856. Program engine 852 operates to control and to facilitate the various functions of universal music apparatus 850 that are discussed herein, from accepting user inputs to generating user outputs. Program engine 852 operates also to control the discovery process of universal discovery module 860. Upper layer 852 includes higher-level data representations and/or executable program instructions for effectuating music database querying, such as providing a user interface (e.g., for accepting query data and for presenting music-related data) as well as application layer processing. Object layer 854 includes intermediate-level data representations and/or executable program instructions for maintaining representations of music servers as music server objects (“MSOs”) 853 and other music-related objects, according to an embodiment of the invention. Objects, such as music server object 853, are used to translate or map relatively sophisticated discovery, communication and/or data access protocol instructions into music server objects (and vice versa) in terms that are independent to any specialized server process. As such, the functionalities defined by music server object 853, such as “search title=SONG TITLE,” can be expressed in a manner that is easily understood by those having little or no experience in programming the specialized server processes. In some embodiments, a portion of object layer 854 includes at least a repository for storing music server objects. Server process interface layer 856 includes lower-level data representations and/or executable program instructions for managing the exchange of data among universal music apparatus 850 and music servers 812, 822, and 832.

Server process interface layer 856 includes, in whole or in part, server process interfaces, such as server process A interface (“SP A I/F”) 856a, server process B interface (“SP B I/F”) 856b, and server process C interface (“SP N I/F”) 856c. Each server process interface is composed of one or more sets of executable instructions that are specific to one of server processes 814, 824 and 834, with each set being mapped to a corresponding generalized server function. Notably, each server process interface is configured to exchange data in accordance with a unique communications protocol, such as those implemented with or as part of either UPnP or DAAP processes, for instance. As an example, consider that a generalized server function “search,” which is independent of any music server process, is implemented in the following snippet of pseudo-code: “search album title=ALBUM TITLE.” This code is configured to search collections of albums for those albums that contain the string “ALBUM TITLE” in the title). If that generalized server function were mapped to server process A interface 856a, then a first set of executable instructions would implement a UPnP process, so long as music server (“1”) 812 is a UPnP server. But if the generalized server function were mapped to server process B interface 856b, then a second set of executable instructions would implement a DAAP process, so long as music server (“2”) 822 is a DAAP server. Note that server process C interface (“SP N I/F”) 856c can represent executable instructions for implementing a process for any other type of music server, such as a SlimServer, which is open source software.

Universal discovery module 860 is configured to automatically discover and identify networked devices capable of communicating data to universal music apparatus 850, at least one of those devices being a music server. In a specific embodiment, universal discovery module 860 is composed of a suite of specialized discovery protocols (not shown) for detecting network music servers. Examples of discovery protocols include SSDP and Rendezvous (i.e., Bonjour™ by Apple Computer, Inc.). Universal discovery module 860 operates to detect the presence of a music server, and to determine the server's capabilities. Specifically, it identifies the music server's identifier (or name) and the type of server process contained therein (e.g., UPnP, DAAP, etc.). Each type of server process generally exchanges data with universal music apparatus 850 in accordance with a unique communication protocol. It also can determine whether the user is required to login, whether a password is required, whether the music server is browsable and/or searchable, and other like server capabilities. Universal discovery module 860 is coupled to an object manager (“obj mgr”) 855, which is configured to form an instance of music server object 853 for each music server detected. In particular, universal discovery module 860 conveys the capabilities of a detected music server to object manager 855, which in turn, associates a number of applicable generalized functions to music server object 853 so that a user can interact (e.g., search a playlist) with the user interface (not shown).

Further note that universal music apparatus 850 includes a CODECs/Formats module 864 to support a wide range of music CODECs and formats, such as Audio Codec '97 (“AC'97”), Windows Media Audio (“WMA™”) of Microsoft, Inc., Advanced Audio Coding (“AAC”), Waveform audio format (“WAV”), Audio Interchange File Format (“AIFF”) as co-developed by Apple Computer, Inc., Linear Pulse Code Modulation (“LPCM”) and the like. Further, CODECs/Formats module 864 can also support M3U format (i.e., MPEG Version 3.0), which is a simple text-based list having a file extension of “.m3u,” Advanced Stream Redirector (“ASX”) format, which is a type of XML metafile designed to provide a list of media files, Audio Video Interleave (“AVI”) media format introduced by Microsoft, Inc., a playlist file format (“PLS”) for storing media play lists, and the like.

In addition, universal music apparatus 850 includes a protocols module 863 for providing network communications protocols, such as IP, UDP and TCP, as well as server protocols, including UPnP AV, DAAP, OpenTalk™ by Apple Computer, Inc., SlimServer, and the like. Also, it includes digital rights management (“DRM”) module 866 for decrypting relevant data streams, such as a data stream encrypted in accordance with Windows Media Digital Rights Management 10 (“WM DRM 10”) by Microsoft, Inc. A media browser module 868 can support implementation of a DAAP (i.e., iTunes™ of Apple Computer, Inc.) media browser, Windows Media Connect media browser, generic UPnP media browser, an internet radio browser, and the like.

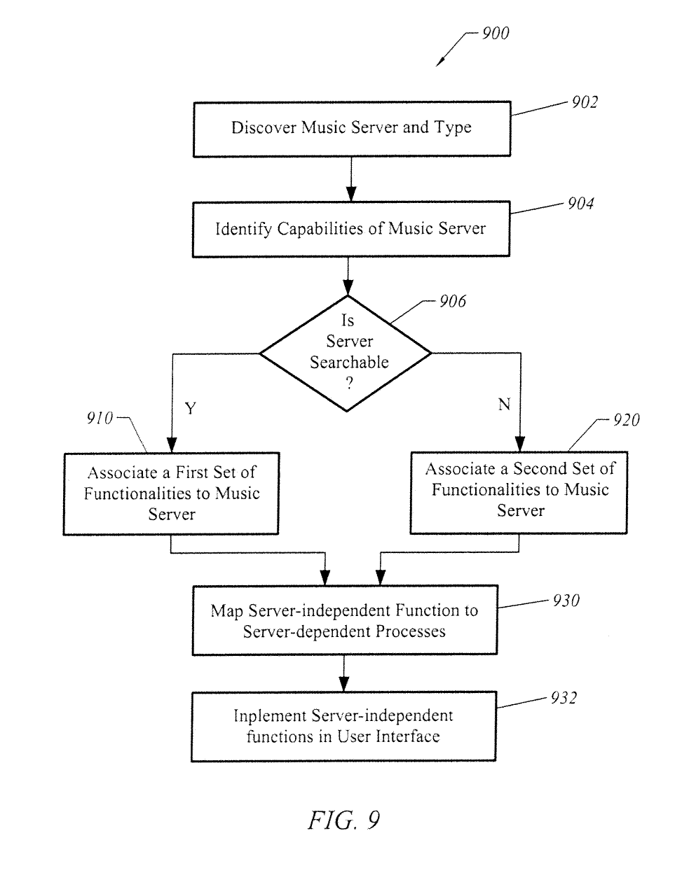

Universal music apparatus 850 can include a radio (“AM/FM”) tuner 862 to receive broadcasted AM radio or FM radio over the air waves, or both. It can also include a port 892 for receiving portable media 890, such as a flash memory-based medium. Advantageously, universal music apparatus 850 facilitates access by a target device to radio tuner 862 and portable media 890 as pseudo-music servers. In at least one embodiment, UMIA 870 is configured to support a telnet connection, such as establishing a telnet session using either TCP port 5555 (e.g., at the IP address of universal music apparatus 850), TCP port 4444 (e.g., telnetting from a client host to port 4444 at the IP address), or the like. As such, there are other ways to send generalized commands to universal music apparatus 850 without using a UMDL. As is described next, universal music apparatus 850 implements an exemplary method of FIG. 9 to discover music servers and to form music server objects 853 as instances of those music servers.

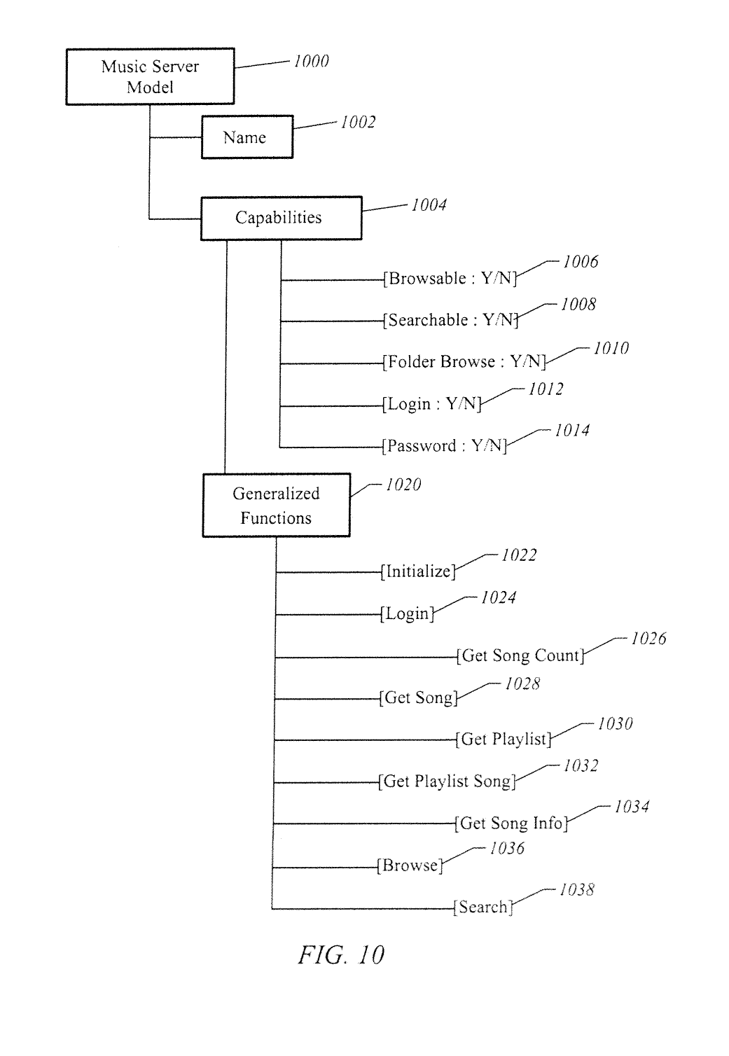

FIG. 9 is a flow diagram exemplifying a method with which universal music apparatus 850 forms or implements a music server object, according to an embodiment of the invention. At 902, a universal discovery module uses one or more relevant discovery protocols to transmit or broadcast probes via a network to networked devices. Any music server configured to recognize the protocol of a particular probe will respond in kind. A responding music server typically returns its type of server, such as UPnP or DAAP, back to the universal discovery module. At 904, universal discovery module determines the capabilities of a responding music server, with some of those capabilities being discussed herein, with respect to a music server model of FIG. 10. An object manager receives and then uses those capabilities to form a generalized representation of a music server discovered at 902.

At least one of those capabilities defines whether the music server is searchable (i.e., can be queried to any degree of granularity using a specific data access protocol) or whether it just has a capability to browse data structures containing music and other music-related data. If the object manager at 906 determines it is searchable, then at 910 it forms a music server object that has a first set of generalized functionalities that each map to, or are associated with, server-dependent sets of executable instructions. This mapping occurs at 930. But if at 906 the object manager determines that the server is not searchable (i.e., it only provides browsing capabilities), then it forms a music server object that has a second set of generalized functionalities at 920. In a specific embodiment, the first set of generalized functions maps to music servers capable of searching and querying the music files, whereas the second set maps to music servers capable of only browsing. At 932, a user via a user interface can implement the generalized functions of the music server to listen to music or to manage the playback thereof. In some embodiments, activity at 932 occurs subsequent to the “initialization” of the server, whereby initialization establishes an active connection with a music server.

FIG. 10 shows an example of a music server model from which a music server object is formed, according to one embodiment of the invention. Music server model 1000 provides an application, such as user interface application, with a common view and a generalized way of interfacing to an element of server functionality implemented in accordance with a specialized server process. As shown, music server model 1000 is associated with a name 1002, which can be a property indicative of the music library implemented with a particular server process. For example, music server model 1000 can associate “Dan's Music Library” to name 1002. A universal music apparatus will display this name on its user interface so that it can be selected. Upon determining the capabilities of a particular server, an object manager will define its capabilities 1004 according to associated properties from 1006 to 1014. As shown, property 1006 indicates whether the particular server is browsable (i.e., “Y” indicates yes) or not (i.e., “N,” indicates no), whereas property 1008 indicates whether the particular server is searchable or not. Property 1010 indicates whether the music server supports Folder Browse (sometimes referred to as “Browse-by-Folder”), which is typically implemented in UPnP servers that do not implement searching capabilities. As used herein, the term “Folder Browse” is used in some embodiments to describe a capability of a music server to represent a music library (i.e., a collection of music and music-related files) of a hierarchy for one or more folders, such as a folder named “90s Tunes.” With this hierarchy, a user can drill down into each folder to manually search for a music file. For example, a music server implementing Folder Browse can hierarchically arrange folders to represent “genre” as a parent folder, with one of the child folders being “rock music.” Then, an “artist” folder contained within “rock music” folder can contain folders for the artist's “albums,” each of which in turn contains songs and/or song data files. Property 1012 and property 1014 indicates whether the server requires a login and a password, respectively.

Once properties 1006 to 1014 are determined, those properties predetermine which functions of generalized functions 1020 are useable with respect to a particular server. Each of generalized functions 1020 is associated with, or are mapped to, a set of executable instructions that are server-dependent to realize, for example, server process interfaces 856a to 856c (FIG. 8). An initialize function 1022 is associated with a set of instructions that initializes a music server to establish a connection between the music server and the universal music apparatus. Login function 1024 maps to instructions implementing a process for logging into a server process. Get Song Count function 1026 is associated with a set of instructions that, for example, determines a number of songs in a collection of songs, whereby the collection of songs can be described by an argument, such as ALBUM. As such, Get Song Count (ALBUM) can retrieve a number of songs in an album. Get Song function 1028 maps to instructions implementing a process for retrieving one or more songs, typically by querying a music server's relational data structure. Get Playlist function 1030 maps user inputs to server-dependent instructions for retrieving the names of one or more play lists, which are listings of user-defined groups of songs. For example, the following snippet of pseudo-code “Get Playlist” causes one or more user-named play lists to be retrieved, such as a play list named “Disco Inferno.” By contrast, Get Playlist Song function 1032 retrieves one or more songs of one or more play lists. For example, consider that the following snippet of pseudo-code “Get Playlist Song (Disco Inferno)” is designed to fetch all songs in the playlist named Disco Inferno. Get Song Info function 1034 is associated with server-dependent instructions that, when executed, retrieve data representing music-related information, such as title, artist, composer, genre, length, track, album, and like information.

Notably, functions browse 1036 and search 1038 are associated with executable instructions for performing a browse and a search of a music server, respectively. Browse function 1036 typically takes an argument, such as ALBUMS, ARTISTS, COMPOSERS, GENRES, and the like. For example, a universal music apparatus executing the following pseudo-code snippet “Browse(COMPOSERS)” will return a listing of composers from which a user can browse for further selection. Similarly, Search function 1038 typically takes an argument, such as ALBUMS, ARTISTS, TITLES, KEYWORDS, and the like, where each are entered as a string to match against a music server. Note that capabilities 1004 and associated properties 1006 to 1014, as well as generalized functions 1020 and associated functions 1022 to 1038 are merely representative of the generalized functions that a universal music apparatus can perform. But in some cases, more or fewer functions can be implemented when modeling a music server in accordance with various embodiments of the invention. For example, generalized functions 1020 can include associations to sets of instructions for: building a song queue to stream digitized music from multiple music servers; reviewing a song queue; erasing a song queue; pausing music playback; and performing other like actions.

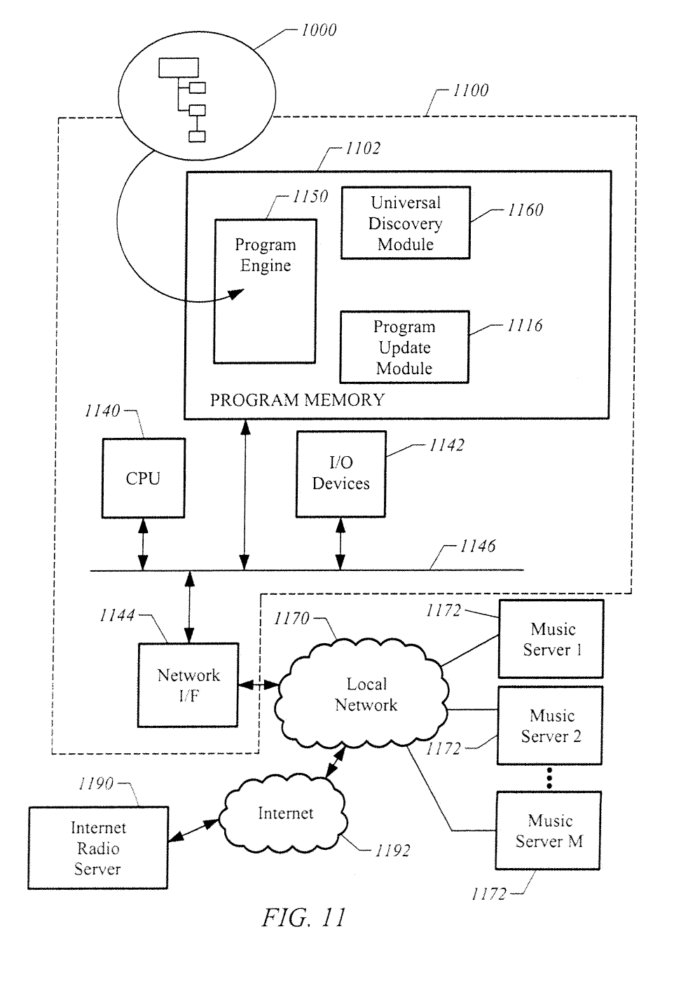

FIG. 11 introduces an architecture in which music server objects (“MSOs”) are implemented in a computing device to unify access to a number of specialized music servers, according to at least one embodiment of the invention. In this example, universal music apparatus 1100 is a computing device composed of hardware modules, software modules, or a combination thereof. Universal music apparatus 1100 includes a program memory 1102 that is connected to bus 1146. Program memory 1102 stores sets of executable programs to implement the functions for the various embodiments of the invention. In one embodiment of the invention, subsets of executable program instructions stored in program memory 1102 constitute program engine 1150 and a universal discovery module 1160. Program engine 1150 and universal discovery module 1160 have similar structures and/or functions as described above. As shown, FIG. 11 depicts an exemplary MSO 1000 of FIG. 11 disposed in program engine 1100, such as in an object layer (not shown). Universal music apparatus 1100 also includes a number of standard components, including a CPU 1140, input/output (“I/O”) devices 1142, such as a user interface (e.g., a graphical display for communicating music-related information and/or speakers for producing music) and/or a remote key pad, and a network interface (“I/F”) 1144, all of which are configured to communicate via a bus 1146. Network I/F 1144 facilitates communications via any kind of local network 1170 to another computing device, such as one that constitutes any of music servers 1172. For example, Network I/F 1144 can facilitate Ethernet communications (e.g., fast Ethernet, such as Ethernet 10/100/1000Mb) as well as wireless communications (e.g., IEEE 802.11b and 802.11g standards, etc.). Network I/F 1144 also facilitates communications with a networked “radio” server 1190, such as an Internet-based server configured to serve (i.e., stream) data representing audio files including music. Networked radio (e.g., Internet radio) is based on the concept of streaming audio. A radio server 1190 sends out a stream of audio signals, in whole or in part, in the form of music files (e.g., MP3 or other like digital audio format) over the network. Users who want to listen to a specific audio stream can instruct universal music server 1100 to connect to the URL of the radio station they want to hear. Universal music server 1100 then directs the stream of audio to a decoder or codec (neither is shown), for example, to play the incoming stream of audio signals.

It should be appreciated that the executable modules illustrated in program memory 1102 are exemplary. The functions of the invention may be implemented in any number of ways. In addition, it should be appreciated that functions of the invention need not be implemented on a single universal music apparatus 1100. The functions of the various embodiments of the invention may be implemented across a set of servers, clients, clients and servers, etc. It is the functions of various embodiments that are significant, not where or how these functions are implemented.

FIGS. 12A and 12B illustrate examples of user interfaces implemented by UI module 516 (FIG. 5), according to one embodiment. FIG. 12A shows UI module 514 supporting generation of a built-in UI that universal media apparatus module 502 generates, according to one embodiment. Here, universal media apparatus module 502 can form a string-based user interface that supports a full range of features, including Internet radio, networked music library browsing, searching, and playback, WiFi setup and configuration, etc. UI module 516 supports displays ranging from 1 to 24 lines in height, automatically configuring its UI to the target device, whether it has, for example, a single line VFD, a two line LCD, or is a TV with 24 lines of display space. In this mode, universal media apparatus module 502 generates and sends processor 510 text strings to display, and then processor 510 displays the strings to the user, and sends user responses back to universal media apparatus module 502. FIG. 12B shows UI module 514 supporting generation of a user-defined UI that universal media apparatus module 502 provides underlying data to display, according to one embodiment. Here, A/V device 500 can implement any arbitrary user interface that a developer wishes. To connect the user interface to universal media apparatus module 502, there is a rich set of control commands of the UMI control protocol that facilitates, for example, browse and search of all networked music libraries and internet radio stations. Because universal media apparatus module 502 abstracts the complicated aspects of talking to different server types, network drivers, protocol stacks, digital rights management and so on, a developer can concentrate on building a unique UI with powerful digital music features.

FIG. 13 depicts the implementation of a play list referencing songs stored in multiple specialized servers, according to one embodiment of the invention. Diagram 1300 shows a target device 1302 implementing a proprietary application program 1304 (e.g., software, firmware, or any kind of executable code) to provide the functionalities of target device 1302. In addition, target device 1302 includes an API 1306 for generating generalized music-related commands. In response to a request from proprietary application program 1304, API 1306 generates and transmits a generalize command (“GC”) 1310, such as a “ListPlaylistSongs” command, to form and/or operate upon a play list 1350. In one embodiment, UMA 1320 receives GC 1310, and, in response, accesses specialized music servers 1332 on network 1330 to create play list 1350 irrespective of the underlying server protocols. For example, UMA 1320 can form a play list 1340 and store it as data representing songs 1342 in program memory 1322. Advantageously, as a single command GC 1310 can generate and/or enable a user to interact with a single list of songs even though song (“1”) 1342a and song (“3”) 1342b are stored on respective servers 1332a and 1332b, both of which are responsive to different communication protocols. In this example, server 1332a and server 1332b operate in accordance with UPnP and DAAP, respectively.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the invention to any embodiment; rather features and aspects of one embodiment may readily be interchanged with other embodiments. For example, although the above descriptions of the various embodiments relate to music and music servers, it is intended to apply to media/multimedia servers that can stream and/or provide video and still images along with audio.

Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the invention; rather any specific embodiment can provide one or more of the advantages discussed above. It is intended that the following claims and their equivalents define the scope of the invention.

1. An apparatus for providing music-related requests from a target electronic device to one or more specialized music servers operating with different server protocols, said apparatus comprising:
a request decoder configured to decode a music-related request to communicate with at least one specialized music server using one of a plurality of different server protocols;
a command control protocol module configured to generate a generalized music-related command in response to said music-related request;
a universal music apparatus module configured to access multiple specialized music servers in response to said generalized music-related command; and
a universal media data link configured to convey said generalized music-related command from said command control protocol module to said universal music apparatus module,
wherein said multiple specialized music servers implement incompatible server protocols.

2. The apparatus of claim 1 wherein said command control protocol module is further configured to generate a music-related command for forming a play list of songs for playing,
wherein said play list includes songs composed of music data stored on said multiple specialized music servers.

3. The apparatus of claim 1 wherein said command control protocol module is further configured to generate a synchronous music-related command requiring a response from said universal music apparatus module before said command control protocol module transmits a subsequent music-related command.

4. The apparatus of claim 3 wherein said synchronous music-related command is a single command that causes said universal music apparatus module to identify said multiple specialized music servers using different discovery protocols.

5. The apparatus of claim 1 wherein said command control protocol module is further configured to generate an asynchronous music-related command that forms one or more responses as said universal music apparatus module performs one or more subsequent music-related commands.

6. The apparatus of claim 5 wherein said asynchronous music-related command is a single command that causes said universal music apparatus module to retrieve music-related information from said multiple specialized music servers using different communication protocols.

7. The apparatus of claim 6 wherein said music-related information includes information about artists, titles, composers, genres, albums and play lists.

8. The apparatus of claim 1 wherein said apparatus is formed on substrate including either a printed circuit board (“PCB”) or a semiconductor wafer.

9. A computer readable medium including executable instructions to provide music-related requests from a target electronic device to multiple specialized music servers operating with different server protocols via a network, said computer readable medium comprising executable instructions to:
detect a request to access music associated with said multiple specialized music servers; and
decode said request as either a synchronous command or an asynchronous command, either of which is configured to access any of said multiple specialized music servers,
wherein said synchronous command and said asynchronous command are generalized commands.

10. The computer readable medium of claim 9 further comprising executable instructions to transmit either said synchronous command or said asynchronous command to a universal music apparatus module, which generates server-specific commands associated with said generalized commands.

11. The computer readable medium of claim 9 wherein said synchronous command is a single ListServers command for generating a list of one or more of said multiple specialized music servers using multiple discovery protocols.

12. The computer readable medium of claim 9 wherein said synchronous command is a single SetServerFilter command for selecting one or more subsets of multiple specialized music servers, at least one of said subsets including music servers sharing a common communications protocol.

13. The computer readable medium of claim 12 wherein others subsets include one or more of the following: a portable media device including a flash memory-based device, a list of internet radio stations, and a radio tuner.

14. The computer readable medium of claim 9 wherein said asynchronous command is a single command to generate a list relating to one of the following music-related information from said multiple specialized music servers: songs, albums, artists, composers, genres, play lists, and play list songs.

15. The computer readable medium of claim 14 wherein said asynchronous command includes a string of alpha-numeric characters as an argument for searching said multiple specialized music servers to retrieve music-related information for a particular song, album, artist composer, genre, play list, or play list songs.

16. The computer readable medium of claim 9 further comprising executable instructions to:
decode said request as a transport command that includes any of the following generalized commands: play, pause, next, previous, stop, shuffle, and repeat,
wherein said transport command is a generalized command that a universal music apparatus module executes to generate a respective server-specific command.

17. An apparatus for providing requests from a target electronic device as generalized commands for interacting with one or more specialized media servers operating with different server protocols, said apparatus comprising:
a universal media interface including:
a request decoder configured to decode a request to communicate with a specialized media server from a proprietary application program of a target device to form a decoded request; and
a command control protocol module configured to generate a generalized command for invoking a response from any of said one or more specialized media servers independent of said different server protocols, said generalized command being based on said decoded request.

18. The apparatus of claim 17 wherein said universal media interface is further configured to transmit said generalized command via a universal media data link to a universal music apparatus, wherein said universal music apparatus generates a server-specific command for said specialized media server in response to said generalized command.

19. The apparatus of claim 17 wherein said command control protocol module is further configured to generate a generalized command that initiates different discovery protocols to identify multiple specialized media servers.

20. The apparatus of claim 19 wherein said command control protocol module is further configured to generate another generalized command that initiates different communication protocols to interact with said multiple specialized media servers.

21. The apparatus of claim 20 wherein said different discovery protocols include Bonjour™ and Simple Service Discovery Protocol (“SSDP”), and said different communications protocols include Universal Plug and Play™ (“UPnP”) protocol and Digital Audio Access Protocol (“DAAP”).

22. The apparatus of claim 17 further comprising a universal media player application program interface (“API”) module for implementing at least said request decoder to decode instructions of said proprietary application program.

23. The apparatus of claim 17 wherein said target device is any consumer electronic device, including an A/V receiver, a television set, a personal digital assistant (“PDA”), a radio, a portable media player including a Digital Video Disc (“DVD”) player and a wireless phone.
